(19) United States
(12) Patent Application Publication
(10) Pub. No.: US 2026/0089172 A1
(43) Pub. Date: Mar. 26, 2026

(54) METHODS, APPARATUSES AND COMPUTER PROGRAM PRODUCTS FOR FACILITATING DETECTION OF MALICIOUS CONTENT ON PLATFORMS

(71) Applicant: WhatsApp, LLC, Menlo Park, CA (US)

(72) Inventors: Sumit Shyamsukha, San Francisco, CA (US); Nikita Machindra Vikhe, Woodinville, WA (US); Rupesh Kumar, Milpitas, CA (US); Anuja More, Fremont, CA (US)

(21) Appl. No.: 18/894,547

(22) Filed: Sep. 24, 2024

(51) Int. Cl. H04L 9/40

(52) U.S. Cl. CPC H04L 63/1416; H04L 63/1425; H04L 63/20

(57) ABSTRACT

A system and method for determining malicious content associated with a platform(s) are provided. The system may analyze one or more communications of users associated with a platform. The system may implement a machine learning model including training data pre-trained, trained in real-time, or periodically trained based on one or more behavior content items associated with one or more accounts associated with the platform and content determined as being malicious. The system may determine, by implementing the machine learning model, whether the at least one communication of the one or more communications include malicious content based on determining at least one score by the machine learning model. The system may block the malicious content from being sent to other users of the platform in response to determining that the at least one score denotes that the at least one communication includes the malicious content.

### TECHNOLOGICAL FIELD

Exemplary aspects of this disclosure may relate generally to methods, apparatuses and computer program products for providing techniques that facilitate detection of malicious content on platforms.

### BACKGROUND

Currently, some existing systems may detect malicious uniform resource locators (URLs). However, these existing systems typically may not solve issues for some unique problems pertaining to detecting malicious URLs on end-to-end encrypted platforms. For instance, with end-to-end encrypted platforms, systems typically may lack access to content sent among users across the end-to-end encrypted platforms. This lack of access to the content, which may include URLs, may thus inhibit/hinder detection of malicious URLs in the content.

Additionally, some existing detection methods may lack context and techniques to detect unique scam patterns as scammers may use deceptive link tactics such as, for example, in application (in-app) redirection of messaging groups, altered domains, one click away (OCA) redirection using, for example, a button click to bypass existing methods of scam detection.

As such, it may be beneficial to provide efficient and reliable mechanisms that provide enhanced techniques to detect malicious content within, or associated with, systems.

### BRIEF SUMMARY

Some examples of the present disclosure may provide techniques and mechanisms that facilitate efficient and reliable approaches to provide techniques that facilitate detection of malicious content on, or associated with, platforms.

Some exemplary aspects of the present disclosure may provide a machine learning (ML) model and/or artificial intelligence (AI) model that may provide techniques to determine unique scammer techniques on, or associated with, end-to-end platforms involving data/content which may include redirection to other message groups (e.g., chat groups), altered domains and/or one click away redirection communications (e.g., messages).

Additionally, the machine learning model and/or the artificial intelligence model may detect malicious content (e.g., in messages) in which access to content may not typically be initially available because communications of content may be within, or across/through, encrypted end-to-end platforms. The machine learning model and/or the artificial intelligence model may also be capable of detecting malicious content in systems having high volume operations (e.g., associated with billions of users) and a corresponding high volume of content (e.g., messages, reports, etc.). The machine learning model and/or the artificial intelligence model may address the problem(s) of detecting and preventing the spread of malware, scams, phishing attacks through URLs shared/communicated within messages on end-to-end platforms.

The machine learning model and/or the artificial intelligence model may analyze content and may detect URLs to determine potential threats (e.g., potential security threats), which may help improve the accuracy and efficiency of malicious content detection (e.g., malicious URL detection) on a network, system, platform (e.g., an end-to-end platform(s)) or the like.

The machine learning model and/or the artificial intelligence model may detect malicious URLs utilized for phishing, malware, and/or scams. The machine learning model and/or the artificial intelligence model may be trained, based in part, on using data as training data from a platform(s), which may allow the machine learning model and/or the artificial intelligence model to learn/predict patterns and features that are specific to the platform(s) itself. The machine learning model and/or the artificial intelligence model solves the problem(s) of detecting and preventing the spread of scams, malware and phishing through URLs shared on a platform by providing a manner (e.g., an automated manner) to detect/determine malicious URLs and perform enforcement (e.g., ban/close) on accounts sending malicious URLs.

By providing an automated and efficient manner to detect and prevent these types of threats (e.g., scams, phishing attacks, malware threats), the exemplary aspects of the present disclosure may help protect users associated with a platform(s) and may improve the overall safety and security of the platform(s) (e.g., enhancing network security).

In one example of the present disclosure, a method is provided. The method may include analyzing one or more communications of users associated with a platform. The method may further include implementing a machine learning model comprising training data pre-trained, trained in real-time, or periodically trained based on one or more behavior content items associated with one or more accounts associated with the platform and content determined as being malicious. The method may further include determining, by implementing the machine learning model, whether at least one communication of the one or more communications comprise malicious content based on determining at least one score by the machine learning model. The method may further include blocking the malicious content from being sent to other users of the platform in response to determining that the at least one score denotes that the at least one communication comprises the malicious content.

In another example of the present disclosure, an apparatus is provided. The apparatus may include one or more processors and a memory including computer program code instructions. The memory and computer program code instructions are configured to, with at least one of the processors, cause the apparatus to at least perform operations including analyze one or more communications of users associated with a platform. The memory and computer program code are also configured to, with the processor(s), cause the apparatus to implement a machine learning model comprising training data pre-trained, trained in real-time, or periodically trained based on one or more behavior content items associated with one or more accounts associated with the platform and content determined as being malicious. The memory and computer program code are also configured to, with the processor(s), cause the apparatus to determine, by implementing the machine learning model, whether at least one communication of the one or more communications comprise malicious content based on determining at least one score by the machine learning model. The memory and computer program code are also configured to, with the processor(s), cause the apparatus to block the malicious content from being sent to other users of the platform in response to determining that the at least one score denotes that the at least one communication comprises the malicious content.

In yet another example of the present disclosure, a computer program product is provided. The computer program product may include at least one non-transitory computer-readable medium including computer-executable program code instructions stored therein. The computer-executable program code instructions may include program code instructions configured to analyze one or more communications of users associated with a platform. The computer program product may further include program code instructions configured to implement a machine learning model comprising training data pre-trained, trained in real-time, or periodically trained based on one or more behavior content items associated with one or more accounts associated with the platform and content determined as being malicious. The computer program product may further include program code instructions configured to determine, by implementing the machine learning model, whether at least one communication of the one or more communications comprise malicious content based on determining at least one score by the machine learning model. The computer program product may further include program code instructions configured to block the malicious content from being sent to other users of the platform in response to determining that the at least one score denotes that the at least one communication comprises the malicious content.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 is a diagram illustrating an exemplary URL in accordance with exemplary aspects of the present disclosure.

FIG. 5 is a diagram illustrating content associated with an exemplary URL in accordance with exemplary aspects of the present disclosure.

FIG. 6 is a diagram illustrating an example of a scam-based group chat in accordance with exemplary aspects of the present disclosure.

FIG. 7 illustrates an example of a machine learning framework in accordance with one or more examples of the present disclosure.

FIG. 8 illustrates an example flowchart illustrating operations for determining malicious content associated with a platform(s) in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non- transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, malicious content may, but need not, include, for example, one or more items of content including URLs associated with phishing (e.g., phishing attacks), scams, malware, and/or the like. In some instances, an example of a phishing attack may include, but is not limited to, a user(s) providing bank, financial or other personal information to an unknown entity without intention of providing such information and typically in response to some unsolicited communication to the user(s). Additionally, in some instances an example of a malware attack may include, but is not limited to, a click, a selection, or the like of a link(s) that may initiate install of an application(s) on a communication device of a user(s) to obtain personal user information (e.g., banking information, etc.). Further, in some instances an example of a scam attack may include, but is not limited to a communication to a user(s) involving fraud, for example based on a communication from an unknown party soliciting information (e.g., personal information), payment or romantic interest, etc.

As referred to herein, an end-to-end encryption platform(s) may be a platform(s), system(s), network(s), or the like in which only the users receiving/sending communications (e.g., messages) may be able to access the communications among the users. In some examples, the platform(s), system(s), network(s) itself may be unable to access the communications (e.g., encrypted communications) unless the user(s) provides authorization to access the communications and the user(s) may need to provide, to the platform(s), system(s), network(s) an encryption key(s) associated with the communications in order to allow the platform(s), system(s), network(s) access to the communication(s).

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

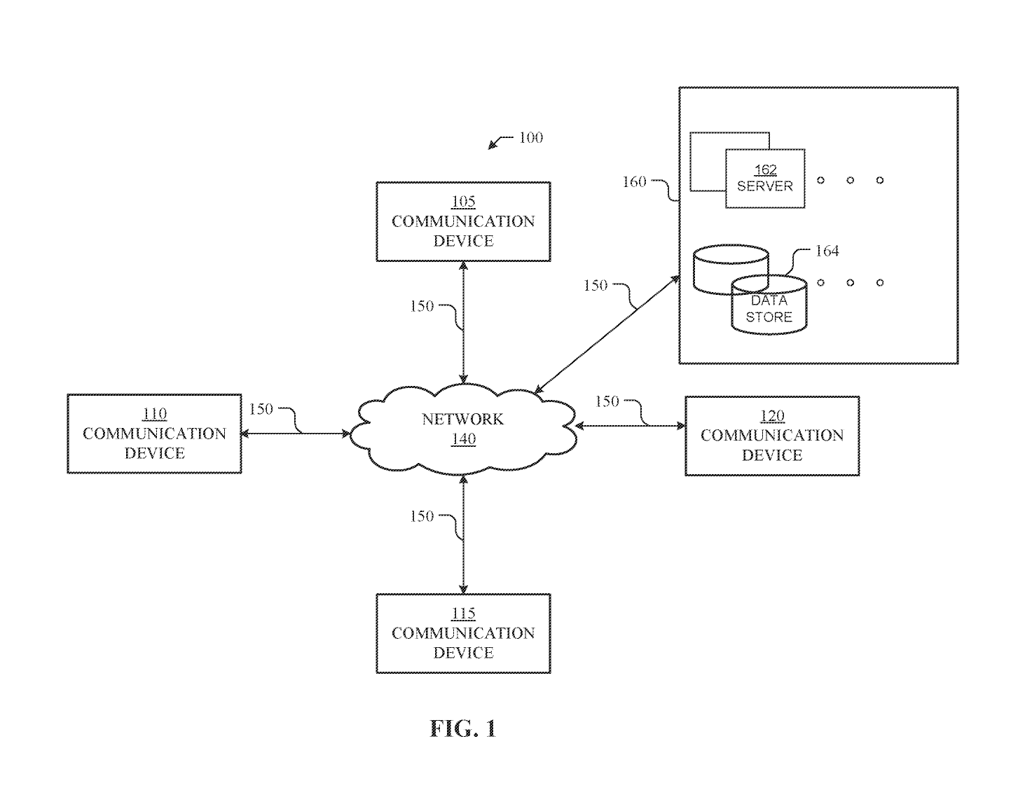

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

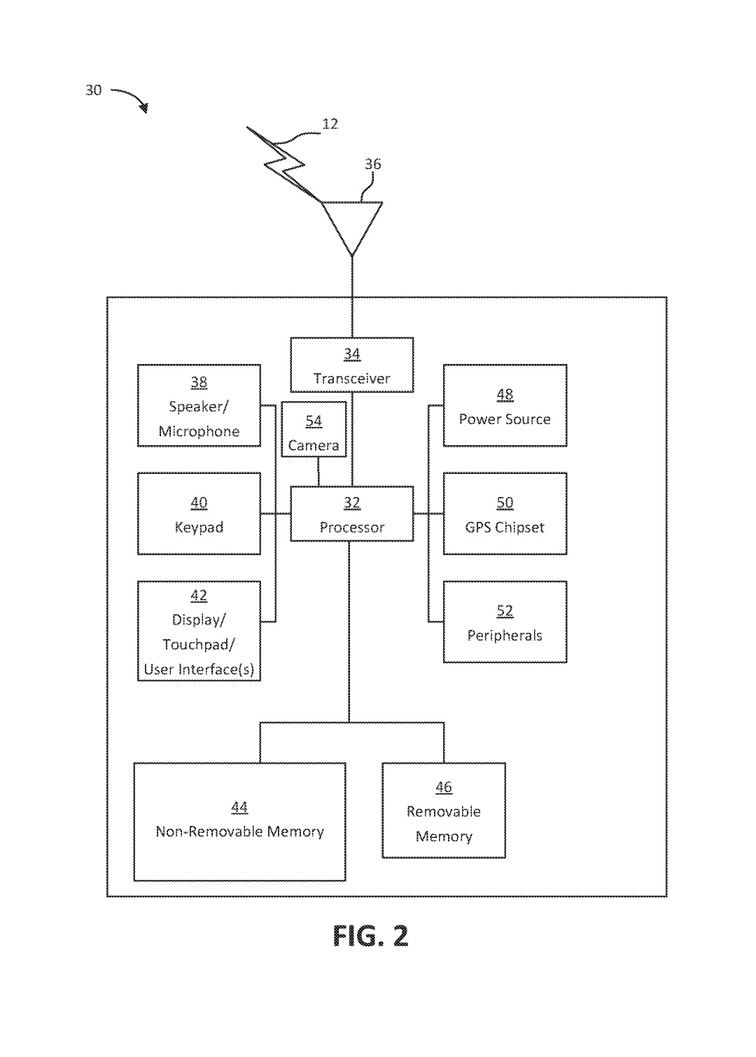

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

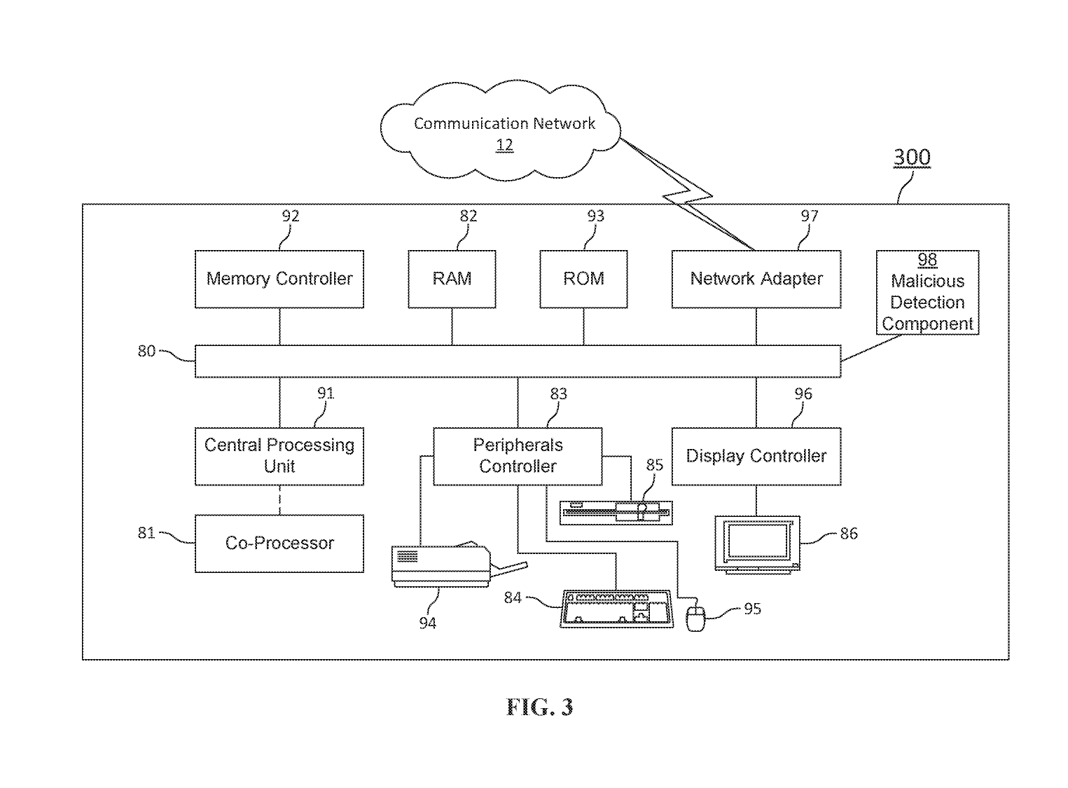

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer’s main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

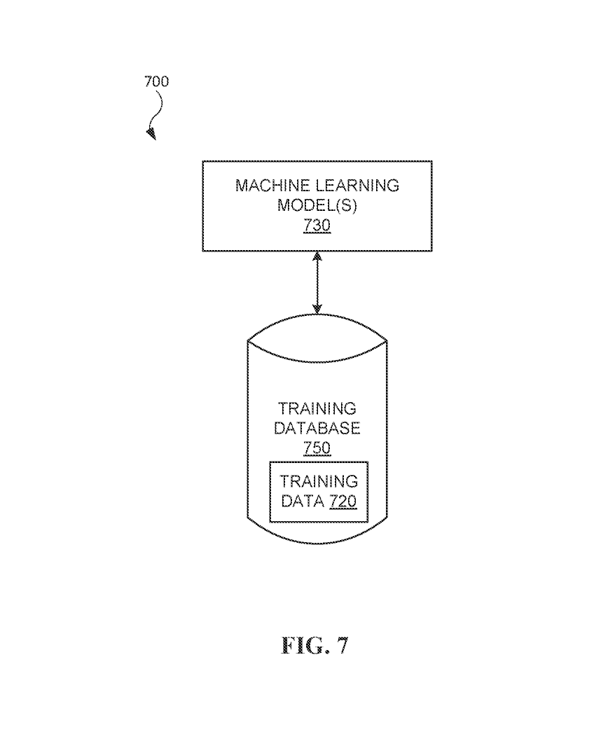

The computing system 300 may also include a malicious detection component 98. The malicious detection component 98 may provide approaches and techniques to facilitate detection of malicious content on platforms, systems, networks, or the like. In some examples, the malicious detection component 98 may implement a machine learning model (e.g., machine learning model(s) 730 of FIG. 7) and/or an AI model that may be pre-trained, trained in real-time, and/or periodically trained with training data (e.g., training data 720 of FIG. 7) to detect and prevent the spread of threats involving for example malware, scams and/or phishing attacks associated with detected malicious URLs shared/communicated on, or associated with, platforms, systems, networks, or the like, as described more fully below.

In some examples, the malicious detection component 98 may evaluate one or more communications (e.g., messages) on a platform, system, network, or the like suspected as including malicious content (e.g., malicious URLs). In an instance in which the malicious detection component 98 determines that a communication (e.g., a message) contains malicious content (e.g., a malicious URL(s)), the malicious detection component 98 may block the malicious content from being sent in other communications to users by or on behalf of an account associated with a sender(s) of the malicious content. In some examples, the malicious detection component 98 may facilitate banning of the account(s) associated with the sender(s) of the malicious content, as described more fully below.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process’s virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary System Operation

Some examples of the present disclosure may provide approaches and techniques to facilitate detection of malicious content on platforms, systems, networks, or the like. Some aspects of the present disclosure may provide a malicious detection component (e.g., an artificial intelligence model, a machine learning model (e.g., machine learning model(s) 730)) that may address problems of detecting and preventing the spread of threats (e.g., network security threats) involving for example malware, scams and/or phishing attacks associated with, or through, URLs shared/communicated on, or associated with, platforms, systems, networks, or the like.

Some existing systems may not be effective in detecting these types of threats as scammers may use advanced redirection and obfuscation techniques associated with content (e.g., malicious URLs) to evade detection. Additionally, the vast volume of content shared on some platforms may make it difficult for traditional manual review methods, of some existing systems, to keep pace with detection of malicious content. The exemplary aspects of the present disclosure may overcome these drawbacks of some existing systems by analyzing content (e.g., messages including URLs) and determining potential threats (e.g., potential network security threats), which may help improve the accuracy and efficiency of detecting malicious content (e.g., malicious URLs in messages) on a platform(s), system(s), or network(s).

In some example aspects of the present disclosure, in an instance in which a user(s) associated with a platform (e.g., system 100) identifies one or more accounts of users or entities as communicating suspicious content, such as for example suspicious malicious URLs, to users on the platform, this user identifying such suspicious communications/activity may report the account(s) of the user/entity engaging in the suspicious communications/activity to the platform. The users may utilize a communication device (e.g., UE 30) to report the suspicious communications/activity to a network device (e.g., computing system 300) of the platform.

Based on the users reporting the suspicious accounts, the reporting users may opt-in to the platform accessing the data associated with communications (e.g., messages) that may be suspicious. Additionally, based on these reporting users reporting the suspicious accounts, these reporting users may be notified by the platform (e.g., by a network device of the platform) that the reporting users are choosing to allow access and analyzing of the communications (e.g., messages) by the platform. In this regard, for example, the network device (e.g., computing system 300) may access a predetermined threshold of communications associated with the user(s) reporting the suspicious account(s) of the user(s) or entity sending content. The predetermined threshold may be, for example, a predetermined number/quantity (e.g., the 5 most recent, 6 most recent, etc.) of communications (e.g., messages) by or associated with the account(s) of the user(s) or entity being suspected as suspicious. In some examples, the network device may access the predetermined threshold of communications associated with the user(s) in an instance in which the user reporting the suspicious account(s) decrypts the predetermined threshold of communications and sends the predetermined threshold of communications to the network device.

By users reporting the account(s) of the user/entity engaging in the suspicious communications/activity to the platform, these reporting users may not be specifically reporting that the content (e.g., URL(s)) of communications is suspicious. Instead, the reporting users may be reporting that the account(s) of the user or entity is suspicious. As such, the users reporting the account(s) of the user/entity engaging in the suspicious communications/activity may not inform the platform about the malicious content itself, and such reporting may inform the platform that this account(s) is likely to be an account of a sketchy/suspect actor or a bad actor.

In response to analyzing, by a malicious detection component (e.g., malicious detection component 98), the data of the predetermined threshold of communications (e.g., the 5 most recent communications), associated with the account(s) of the suspicious user or entity, the network device (e.g., computing system 300) may designate the account(s) of the suspicious user or entity as being banned from the platform such that the banned account(s) may be unable to send/receive additional communications (e.g., messages) across the platform. In some exemplary aspects of the present disclosure, the malicious detection component 98 (e.g., machine learning model(s) 730) may analyze one or more of the predetermined threshold of communications and may determine a score between values 0 and 1 associated with data (e.g., a URL(s)) of the predetermined threshold of communications to determine that data/content of the predetermined threshold of communications is malicious.

In this regard, in an instance in which the malicious detection component 98 determines that one or more of the predetermined communications has a predetermined threshold score between the values 0 and 1, the malicious detection component 98 may determine there is a high confidence/likelihood that the data (e.g., a URL(s)) is malicious. In some examples, for purposes of illustration and not of limitation, in an instance in which the malicious detection component 98 determines a threshold score of 0.95, the malicious detection component 98 may determine that a communication(s) (e.g., a URL) is likely malicious/bad. In other examples, the malicious detection component 98 may determine that one or more other threshold scores (e.g., 0.90, 0.85, etc.), denotes that a communication(s) (e.g., a URL) is likely malicious/bad.

As an initial stage (e.g., pre-training) in the training of the malicious detection component 98, the network device (e.g., computing system 300) may analyze and utilize account level information (e.g., one or more accounts associated with the platform) as training data for the malicious detection component 98.

In this regard, for example, the training data may be data (e.g., behavior content items associated with an account(s)) associated with how long an account(s) has been registered with a platform, data indicating whether the profile matches other accounts that were banned from a platform, data indicating whether there is a website(s) (e.g., an external website(s)) by a user(s) or entity associated with an account(s), how many users have reported an account(s) as being suspicious within a predetermined time period (e.g., within the prior day, the prior week, etc.), and/or other behavioral information (e.g., when an account(s) was created, how many messages has been sent associated with the account(s), etc.) about accounts as well as content associated with the accounts based on the profiles of users or entities associated with the accounts.

Additionally, there may be account level labels associated with the accounts indicating or denoting whether an account(s) was labeled, classified, or flagged as spam-based, scam-based, or if the account(s) was banned for some kind/type of violation(s). In this regard, the account level label(s) of the training data may be utilized by the malicious detection component 98 to classify or determine whether content (e.g., a URL) may be malicious or bad. For purposes of illustration and not of limitation, if an account level label indicates an account is a spam-based account, the malicious detection component 98 may determine/predict that the likelihood/confidence of content (e.g., content of messages) being evaluated as malicious is high. In some examples, the training data (e.g., training data 720) may include some URLs (e.g., landing page signals, domain registration signals, etc.) associated with accounts that are determined as malicious, and some URLs associated with good accounts (e.g., non-malicious accounts). Additionally, in some examples, the training data may include several predictive features about a URL(s) such as, for example, a number of times the URL(s) has been shared by violating accounts, a number of days since a domain associated with a URL(s) was registered, the text of a landing page of the URL(s), etc.

Additionally, the malicious detection component 98 may be trained in real-time and/or trained periodically. For example, the predetermined threshold of communications (e.g., the 5 most recent messages) that were analyzed as potentially being associated with a suspicious account(s) of a user(s) or entity may be utilized, or implemented, by the network device (e.g., computing system 300) as additional training data for the malicious detection component 98. In this regard, the malicious detection component 98 may be trained with training data in real-time. As such, the malicious detection component 98 may be run/implemented on the predetermined threshold of communications (e.g., the 5 most recent messages, the 6 most recent messages, etc.) and these communications may also be utilized by the network device as training data in real-time and/or periodically (e.g., at a particular time each week for retraining the malicious detection component 98).

In a first mode of operation of the malicious detection component 98, the malicious detection component 98 may be run/implemented on communications (e.g., messages) associated with accounts indicated as suspicious, as described above. In an instance in which the malicious detection component 98 determines that content (e.g., a URL(s)) of the communication(s) has a high confidence as being malicious, the malicious detection component 98 may facilitate banning of the account(s) that sent/communicated the malicious content. In some examples, for purposes of illustration and not of limitation, a score(s) such as 0.95 and higher (e.g., 0.97, etc.) may denote a high confidence that content (e.g., a URL) being analyzed is malicious. Additionally, for purposes of illustration and not of limitation, a score(s) below 0.95 may denote a low confidence and as such may indicate that content being analyzed is not malicious. In some examples, the network device (e.g., computing system 300), may facilitate the banning of an account(s) in an instance in which the malicious detection component 98 determines there is a high confidence that the content is malicious. In some other examples, another communication device (e.g., communication device 110) may facilitate the banning of an account(s) in an instance in which the malicious detection component 98 determines there is a high confidence that the content is malicious.

For instance, the malicious detection component 98 may send a notification to another communication device (e.g., communication device 110) to ban an account(s) associated with communicating the malicious content (e.g., a malicious URL). The other communication device may ban the account(s) and in some examples may remove a URL(s) (e.g., a website(s)) associated with the malicious content from a network (e.g., the Internet). The removal may be a takedown of a website from the network (e.g., the Internet) associated with the URL(s).

In this regard, the malicious detection component 98 is capable of restricting one or more accounts from sending malicious content (e.g., a malicious URL(s)) to other users and thus may minimize network security threats and enhance network security associated with a platform. In this manner, in some examples the malicious detection component 98 is capable of facilitating the banning of 20,000 or more accounts per day and thus restricting 300000 or more messages (e.g., scam messages, etc.) per day that typically may have been sent by the banned accounts.

By removing such massive volume of traffic, associated with malicious content, from the platform, the network device (e.g., computing system 300), by utilizing the malicious detection component 98, may conserve bandwidth across the network of a system (e.g., system 100) and thus may enable the communication devices of the system to conserve processing capacity, conserve energy and function more efficiently.

Additionally, by removing such massive volume of traffic, associated with malicious content, from the platform/system, the network device, by utilizing the malicious detection component 98 also enables faster communications of traffic across a system (e.g., system 100) and makes the system more secure for users and enhances protection of computing resources and content associated with the system.

In another exemplary aspect, the malicious detection component 98 may be implemented (in a second mode of operation) with, or on, a cloud-based API on the platform in which the cloud-based API (e.g., a system/network based API) may be an enterprise message delivery platform. The cloud-based API may enable businesses, organizations and/or enterprises to sign up/register with a platform to use the cloud-based API to send communications (e.g., messages) to users of the platform. By utilizing the cloud-based API, there may be potential for many bad actors to attempt abuse of the cloud-based API messaging platform. The reason for this may be because the cloud-based API may provide bad actors access to scale on a platform in which the bad actors may send thousands of messages at once (e.g., in bulk) to users on the platform instead of having to send messages manually, one at a time, or in a brute force manner.

As such, in some exemplary aspects of the present disclosure, the malicious detection component 98 may be run/implemented on, or with, the cloud-based API messaging platform to proactively determine instances in which a user(s), entity, or the like attempts to send communications (e.g., messages) including malicious content (e.g., a bad/malicious URL(s)). In this regard, in an instance in which the malicious detection component 98 detects/determines that the user(s), entity or the like is attempting to communicate/send malicious content (e.g., a bad/malicious URL), the malicious detection component 98 may automatically block/prohibit the communication(s) having the malicious content from being sent/transmitted to one or more users on the platform (e.g., system 100). As such, in some examples, the communications (e.g., messages) with the malicious content may not be received or delivered to the users on the platform. For purposes of illustration and not of limitation, in view of the scale of some platforms (e.g., system 100), the malicious detection component 98 may facilitate the blocking of about 150,000 to 250,000 or more bad/malicious communications (e.g., messages) from being sent by users, entities or the like with malicious intentions each day.

In some example aspects of the present disclosure, there may be a predetermined threshold of communications that the malicious detection component 98 may automatically proactively evaluate when attempting to be sent (e.g., prior to being sent) by, or on behalf of a user(s), entity or the like before communications may be blocked by the malicious detection component 98. For example, in an instance in which a user, entity, or the like of the cloud-based API attempts to send the communications (e.g., messages) of content, the malicious detection component 98 may be run/implemented on the communications to evaluate a predefined/predetermined threshold of the communications (e.g., the first 50,000 messages) attempted at being sent such that the malicious detection component 98 may check the communications as to whether the content of the communications are good (e.g., non-malicious) or malicious. As long as the malicious detection component 98 determines/predicts the content (e.g., URLs) of the communications are good, the communications (e.g., the predefined threshold of communications and associated subsequent communications) may be delivered to users of the platform.

On the other hand, in an instance in which the malicious detection component 98 determines/predicts that the content (e.g., URLs) is malicious, based on evaluating a set of communications (e.g., the predefined threshold of communications), then the malicious detection component 98 may block/prohibit the set of communications from being delivered to users of the platform and may block/prohibit subsequent attempts of sending communications by an API messaging platform that includes the malicious content such that the communications are not transmitted and thus not received by users of the platform.

In some other example aspects of the present disclosure, a platform (e.g., system 100) may provide an approach for users or entities of accounts to appeal to the platform to reinstate their prior banned account(s). For example, there may be a few instances (e.g., 5% or less) of determinations/predictions by the malicious detection component 98 labeling/classifying content as malicious content (e.g., malicious URLs) that may not be malicious (e.g., false positives). In this regard, a user(s) or entity registered with the platform having misclassified content improperly labeled as malicious content may appeal to the platform (e.g., system 100) to have their account(s) reinstated with the platform.

In some examples, the appeals to the platform may be evaluated by (e.g., by user personnel of the platform and/or a network device (e.g., computing system 300)) the platform and in an instance in which it is determined that any errors occurred in misclassification of content as malicious, there may be error correction data determined/identified and included in the training data (e.g., training data 720) associated with the malicious detection component 98 to retrain and update the malicious detection component 98. As such, the accuracy of the malicious detection component 98 may be enhanced. In this regard, in an instance in which the malicious detection component 98 subsequently analyzes similar/same content (e.g., a URL) of a communication(s), the malicious detection component 98 may determine the similar content (e.g., a similar or same URL) is good (e.g., non-malicious) and may not label the similar/same content as malicious.

In this manner, the malicious detection component 98 may be refined and the accuracy in making predictions and determinations by the malicious detection component 98 may be enhanced and thus the security of an associated platform(s) (e.g., system 100) may be more reliable and secure.

As an example of some aspects of the present disclosure, consider for purposes of illustration and not of limitation, an example in which a User A reports (e.g., by using a UE 30) a User B on a platform in which the report(s) may indicate User B as having a suspicious account. In this regard, a network device (e.g., computing system 300) associated with the platform (e.g., system 100) may receive and/or access a prior predetermined threshold of communications associated with the User A and User B. For instance, the prior predetermined threshold of communications may, for example, be the prior/most recent 5 messages sent by User B to User A.

In this example, these messages may include text content which includes one or more URLs, and at least one of the messages may include content indicating “Hi there please visit www.myfictitious.com” (e.g., a fictitious website in this example). In this regard, the malicious detection component 98 may extract the URLs from the text and may then analyze the extracted URLs. The malicious detection component 98 may determine a score between 0 and 1 indicating the likelihood/confidence that one or more of the URLs are malicious. For example, a score of 0.95 or higher value may denote that one or more URLs are malicious. On the other hand, for example, a score below 0.95 may denote that one or more URLs are not malicious.

In an instance in which the malicious detection component 98 determines, based on the score, that one or more of the URLs are malicious, the malicious detection component 98 may facilitate the banning of the account of User B. This determination by the malicious detection component 98 that one or more of the URLs is malicious content may be provided as additional training data (e.g., training data 720) for the malicious detection component 98 to retrain the malicious detection component 98. In some examples, the usage of the detected one or more URLs as malicious content may be provided as additional training data to retrain the malicious detection component 98 on a periodic basis (e.g., a weekly recurring basis).

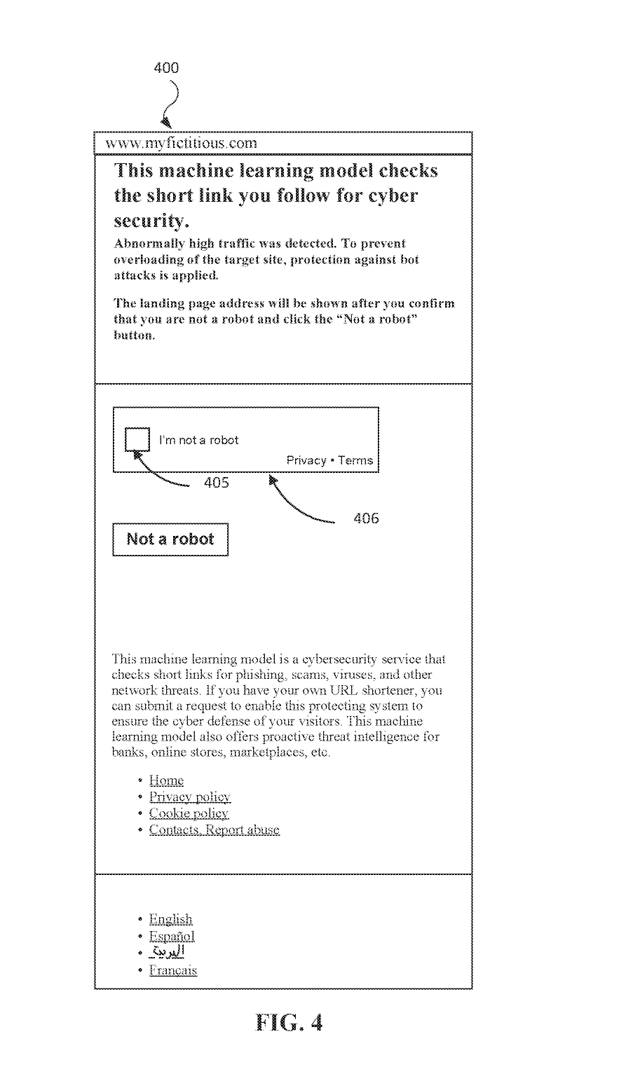

As another example of some aspects of the present disclosure, consider for purposes of illustration and not of limitation, an example in which there is a group chat of Users A, B, C, D, and E. Consider a scenario in which User E sends a malicious URL, for example www.myfictitious.com (e.g., a fictitious website) to one or more of the Users A, B, C, and/or D. Consider FIG. 4 for an illustration of an example of this URL 400.

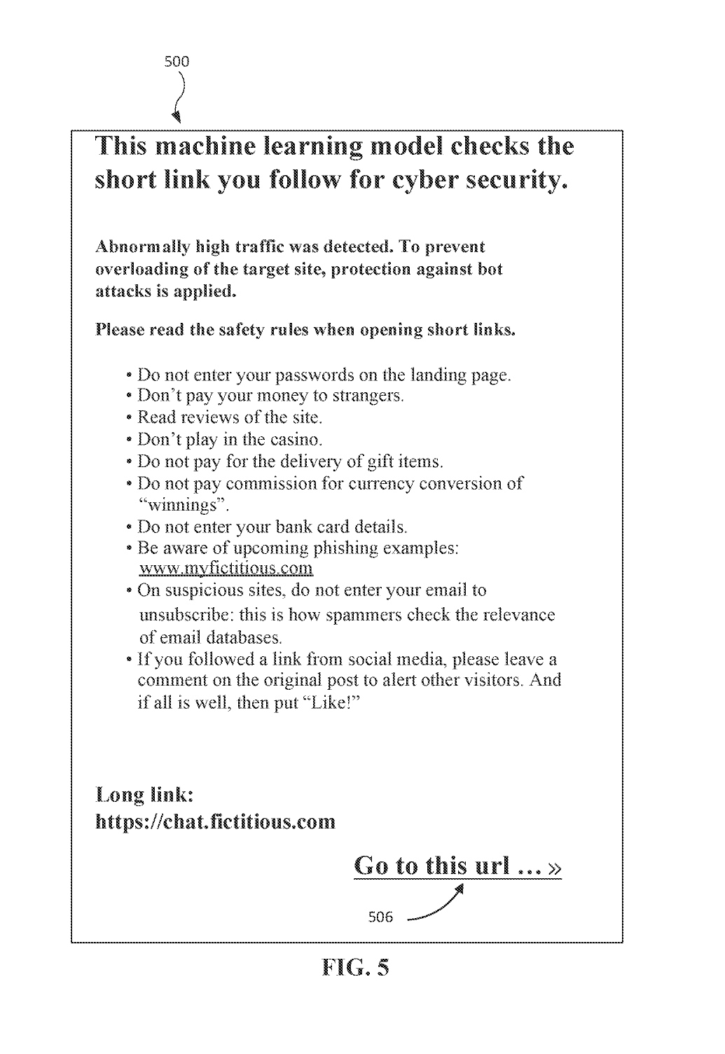

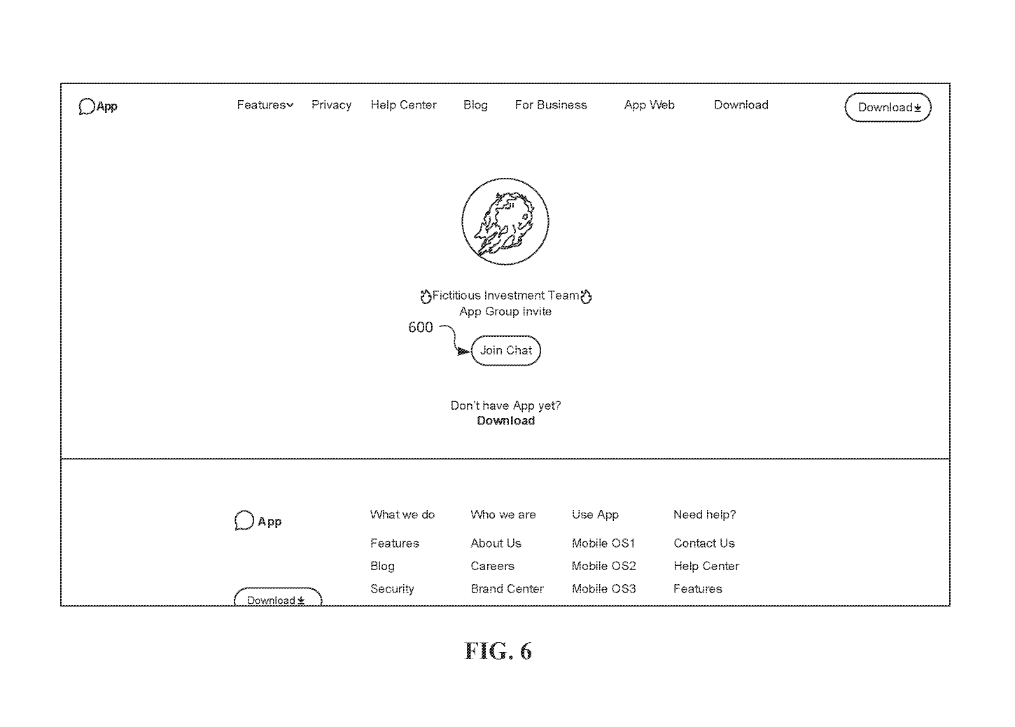

In response to selecting the I’m not a robot box 406 (also referred to herein as I’m not a robot button 406) on, or associated with, the above URL 400, one or more of the recipient Users A, B, C, D may be shown the content 500 (e.g., content associated with another URL (e.g., https://chat.fictitious.com, a fictitious URL)) of FIG. 5 on a display (e.g., display/touchpad/user interface(s) 42) of a corresponding communication device (e.g., UE 30). In response to clicking/selecting a link such as Go to this url … 506 shown in FIG. 5, one or more of the Users A, B, C, and/or D may be added to, or included within, a scam-based chat group 600 shown in FIG. 6.

In an instance in which a user (e.g., User A) reports User E to a platform as being associated with a suspicious account, a network device (e.g., computing system 300) and/or the malicious detection component 98 may retrieve the original URL shared by User E (e.g., www.myfictitious.com). In this regard, the malicious detection component 98 may run or be implemented on this original URL. In this example, the malicious detection component 98 may determine a score between 0 and 1 indicating a likelihood/confidence the original URL (e.g., www.myfictitious.com) as being malicious since this URL may be redirecting one or more of Users A, B, C, and/or D to a scam-based chat group 600. On the basis of being determined as communicating malicious content, the malicious detection component 98 may facilitate the banning of an account associated with User E. In an instance in which a new user in the future attempts to send the same/similar malicious URL and such is reported to the platform by another User (e.g., User F), then the account of the new User (e.g., User F) may also be banned.

In some examples associated with accounts pertaining to a first mode of operation, the malicious detection component 98 may not proactively block (e.g., in advance of a reporting to a platform of a suspicious account by a user(s)) some communications (e.g., messages including a malicious URL(s)) from being sent to users given that the platform associated with these accounts may be end-to-end-encrypted. In response to/after the platform receives a reporting of a suspicious account(s), the malicious detection component 98 may then block the sending of subsequent communications including the malicious content.

In other examples, such as the cloud-based API messaging platform described above for businesses, organizations, and/or enterprises, the malicious detection component 98 may be capable of proactively blocking/prohibiting determined malicious communications (e.g., messages including a malicious URL(s)) from being sent to users. In this regard, in an instance in which malicious content (e.g., a malicious/bad URL) is detected by the malicious detection component 98, the communications (e.g., messages) containing the malicious content may be blocked/prohibited from being delivered to users and the corresponding accounts of these businesses, organizations, and/or enterprises sending malicious content may be banned from the platform.

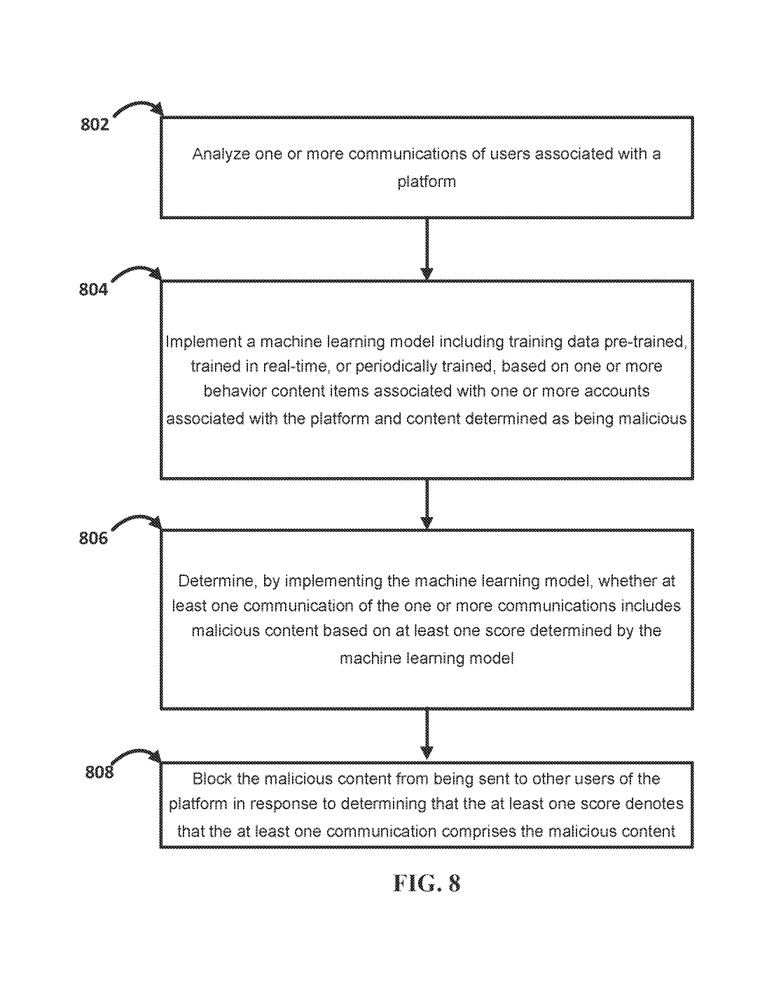

FIG. 7 illustrates an example of a machine learning framework 700 including machine learning model(s) 730 and a training database 750, in accordance with one or more examples of the present disclosure. The training database 750 may store training data 720. In some examples, the machine learning framework 700 may be hosted locally in a computing device or hosted remotely. By utilizing the training data 720 of the training database 750, the machine learning framework 700 may train the machine learning model(s) 730 to perform one or more functions, described herein, of the machine learning model(s) 730. In some examples, the machine learning model(s) 730 may be stored in a computing device. For example, the machine learning model(s) 730 may be embodied within a communication device (e.g., UE 30). In some other examples, the machine learning model(s) 730 may be embodied within another device (e.g., computing system 300). Additionally, the machine learning model(s) 730 may be processed by one or more processors (e.g., processor 32 of FIG. 2, coprocessor 81 of FIG. 3). In some examples, the machine learning model(s) 730 may be associated with operations (or performing operations) of FIG. 8. In some other examples, the machine learning model(s) 730 may be associated with other operations. In some examples, the machine learning model(s) 730 may be an example of the malicious detection component 98.

The training data 720 employed by the machine learning model(s) 730 may be pre-trained, fixed or updated periodically. Alternatively, the training data 720 may be updated in real-time based upon the evaluations performed by the machine learning model(s) 730 in a non-training mode. This may be illustrated by the double-sided arrow connecting the machine learning model(s) 730 and stored training data 720 which may be stored in the training database 750. Some other examples of the training data 720 may include, but are not limited to, items of content determined as being associated with a network (e.g., the Internet, a social network, etc.), a platform (e.g., system 100) or the like.

In some examples, the training data 720 may include account level information (e.g., one or more accounts associated with a platform) for the machine learning model(s) 730. In this regard, some examples of the account level information as the training data 720 may include data (e.g., behavior content items associated with an account(s)) associated with how long an account(s) has been registered with a platform(s), data indicating whether a profile(s) matches other accounts that were banned from the platform(s), data indicating whether there is a website(s) (e.g., an external website(s)) by a user(s) or entity/entities associated with an account(s), how many users have reported an account(s) as being suspicious within a predetermined time period (e.g., within the prior day, the prior week, etc.), and/or other behavioral information/signals (e.g., when an account(s) was created, how many messages has been sent associated with the account(s), etc.) about accounts as well as content associated with the accounts based on the profiles of users or entities associated with the accounts.

Additionally, the account level information as the training data 720 may include account level labels associated with the accounts indicating or denoting whether an account(s) was labeled, classified, or flagged as spam-based, scam-based, or if the account(s) was banned for some kind/type of violation(s). In this regard, the account level label(s) of the training data 720 may be utilized by the machine learning model(s) 730 to classify or determine whether content (e.g., a URL(s)) may be malicious or bad. In some examples, the training data 720 may also include some URLs (e.g., landing page signals, domain registration signals, etc.) associated with accounts that are determined as malicious, and some URLs associated with good accounts (e.g., non-malicious accounts). Additionally, in some examples, the training data 720 may include several predictive features about a URL(s) such as, for example, the number of times the URL(s) has been shared by violating accounts, the number of days since a domain associated with the URL(s) was registered, the text of a landing page of the URL(s), etc.

Additionally, as described above the training data 720 may be trained in real-time and/or trained periodically. For example, the predetermined threshold of communications (e.g., the 5 most recent messages) that were analyzed as potentially being associated with a suspicious account(s) of a user(s) or entity/entities may be utilized, or employed, as additional training data 720 for the machine learning model(s) 730. In this regard, the machine learning model(s) 730 may be trained with training data 720 in real-time and/or as training data 720 trained periodically (e.g., at a particular time each week for retraining the machine learning model(s) 730). In some examples, the training data may include URLs detected both proactively and reactively on a platform(s). For example, proactive URLs may be URLs submitted by businesses/entities before these URLs are sent to users. Reactive URLs may be reported by users to the platform(s) after the users have received these URLs. The training data may include predictive features and labels (e.g., indicating whether training data examples were malicious or non-malicious). The training data may include several predictive features about a URL(s) such as the number of times the URL(s) has been shared by violating accounts, a number of days since a domain was registered associated with the URL(s), the text of a landing page of the URL(s), etc. The training labels may be based on whether an account(s)/URL(s) was considered as violating or not violating based on spam/scam activity or some other violation (e.g., malware).

FIG. 8 illustrates an example flowchart illustrating operations for determining malicious content associated with a platform(s) according to an example of the present disclosure. At operation 802, a device (e.g., computing system 300) may analyze one or more communications (e.g., messages) of users associated with a platform (e.g., system 100). In some examples, prior to analyzing the one or more communications, the device (e.g., computing system 300) may receive an indication (e.g., a report(s)) from at least one user of the users indicating that at least one account of a second user, of the users, initiating the sending one of the at least one communication is suspicious. Additionally, the device (e.g., computing system 300) may access and analyze a predetermined threshold of the one or more communications, based on the receipt of the indication that the at least one account is suspicious. In some examples, the predetermined threshold of the one or more communications may include a predetermined quantity/number of most recent communications (e.g., the 5 most recent communications, 6 most recent communications, 7 most recent communications) of the one or more communications.

At operation 804, a device (e.g., computing system 300) may implement a machine learning model (e.g., machine learning model(s) 730). The machine learning model may include training data pre-trained, trained in real-time, or trained periodically, based on one or more behavior content items associated with one or more accounts associated with the platform and content determined as being malicious. The content determined as malicious in the training data may, but need not, be based on prior or historical determinations of data as being malicious.

At operation 806, a device (e.g., computing system 300) may determine, by implementing the machine learning model, whether at least one communication of the one or more communications includes malicious content based on determining at least one score by the machine learning model. At operation 808, a device (e.g., computing system 300) may block the malicious content from being sent to other users of the platform in response to determining that the at least one score denotes that the at least one communication includes the malicious content.

The malicious content may include one or more malicious URLs. The malicious content and/or the malicious URLs may be aimed at selection, by one or more of the users, of the one or more malicious URLs to engage the one or more of the users in a scam, phishing attack, or being provided malware on one or more communication devices (e.g., UEs 30) of the one or more of the users. In some examples, malicious URLs may include, but are not limited to, the following categories. Phishing URLs which may be URLs that are made to look like official websites (e.g., banking websites, shipping delivery websites, etc.) with a goal of harvesting information about users (e.g., login details, etc.). Malware URLs which may be URLs that may download malicious applications onto a user’s communication device (e.g., UE 30) which may be used to compromise the communication device and extract information. Scam URLs which may be deceptive URLs that may send a user to a website with a promise, for example, of financial gain (e.g., a cryptocurrency investing website, a gambling website, etc.).

The device (e.g., computing system 300) may facilitate, based on the at least one score, banning of at least one account associated with at least one user, of the users, that initiated the sending of the malicious content to at least a second user of the users. The device (e.g., computing system 300) may also automatically block a plurality of communications from being sent to the users based on the at least one score in response to determining that at least one of the plurality of communications are associated with one or more entities having accounts associated with a network-based application programming interface messaging platform. The network-based application programming interface messaging platform may be configured to facilitate sending of the plurality of communications. In some examples, the network-based application programming interface messaging platform may be a cloud-based API messaging platform.

The device (e.g., computing system 300) may determine that the at least one score denotes a high confidence/likelihood that the at least one communication comprises the malicious content. The at least one score may be at least one value. The at least one value may include a value in a range of values from 0 to 1. For purposes of illustration and not of limitation, in some examples, a score value of 0.95 or higher score value may denote a high confidence of content being malicious whereas a score value lower than 0.95 may denote a low confidence of content be malicious (e.g., not malicious).

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
analyzing one or more communications of users associated with a platform;
implementing a machine learning model comprising training data pre-trained, trained in real-time, or periodically trained based on one or more behavior content items associated with one or more accounts associated with the platform and content determined as being malicious;
determining, by implementing the machine learning model, whether at least one communication of the one or more communications comprise malicious content based on determining at least one score by the machine learning model; and
blocking the malicious content from being sent to other users of the platform in response to determining that the at least one score denotes that the at least one communication comprises the malicious content.

2. The method of claim 1, wherein the malicious content comprises at least one malicious uniform resource locator (URL).

3. The method of claim 2, wherein the at least one malicious URL is aimed at selection, by one or more of the users, of the at least one malicious URL to engage the one or more of the users in a scam, phishing attack, or being provided malware on one or more communication devices of the one or more of the users.

4. The method of claim 1, further comprising:
facilitating, based on the at least one score, banning of at least one account associated with at least one user, of the users, that initiated sending of the malicious content to one or more of the users.

5. The method of claim 1, further comprising:
automatically blocking a plurality of communications from being sent to the users based on the at least one score in response to determining that at least one of the plurality of communications is associated with one or more entities having accounts associated with a network-based application programming interface messaging platform configured to facilitate sending of the plurality of communications.

6. The method of claim 1, wherein prior to the analyzing the method further comprises:
receiving an indication from at least one user of the users indicating that at least one account of a second user, of the users, initiating sending of the at least one communication is suspicious.

7. The method of claim 6, further comprising:
accessing and analyzing a predetermined threshold of the one or more communications, based on the receiving the indication that the at least one account is suspicious.

8. The method of claim 7, wherein the predetermined threshold comprises a predetermined quantity of most recent communications of the one or more communications.

9. The method of claim 1, further comprising:
determining that the at least one score denotes a high confidence that the at least one communication comprises the malicious content.

10. The method of claim 1, wherein the at least one score comprises at least one value.

11. The method of claim 10, wherein the at least one value comprises a value in a range of values from 0 to 1.

12. An apparatus comprising:
one or more processors; and
at least one memory storing instructions, that when executed by the one or more processors, cause the apparatus to:
analyze one or more communications of users associated with a platform;
implement a machine learning model comprising training data pre-trained, trained in real-time, or periodically trained based on one or more behavior content items associated with one or more accounts associated with the platform and content determined as being malicious;
determine, by implementing the machine learning model, whether at least one communication of the one or more communications comprise malicious content based on determining at least one score by the machine learning model; and
block the malicious content from being sent to other users of the platform in response to determining that the at least one score denotes that the at least one communication comprises the malicious content.

13. The apparatus of claim 12, wherein the malicious content comprises at least one malicious uniform resource locator (URL).

14. The apparatus of claim 13, wherein the at least one malicious URL is aimed at selection, by one or more of the users, of the at least one malicious URL to engage the one or more of the users in a scam, phishing attack, or being provided malware on one or more communication devices of the one or more of the users.

15. The apparatus of claim 12, wherein when the one or more processors execute the instructions, the apparatus is configured to:
facilitate, based on the at least one score, banning of at least one account associated with at least one user, of the users, that initiated sending of the malicious content to one or more of the users.

16. The apparatus of claim 12, wherein when the one or more processors execute the instructions, the apparatus is configured to:
automatically block a plurality of communications from being sent to the users based on the at least one score in response to determining that at least one of the plurality of communications is associated with one or more entities having accounts associated with a network-based application programming interface messaging platform configured to facilitate sending of the plurality of communications.

17. The apparatus of claim 12, wherein prior to the analyze and wherein when the one or more processors execute the instructions, the apparatus is configured to:
receive an indication from at least one user of the users indicating that at least one account of a second user, of the users, initiating sending of the at least one communication is suspicious.

18. A non-transitory computer-readable medium storing instructions that, when executed, cause:
analyzing one or more communications of users associated with a platform;
implementing a machine learning model comprising training data pre-trained, trained in real-time, or periodically trained based on one or more behavior content items associated with one or more accounts associated with the platform and content determined as being malicious;
determining, by implementing the machine learning model, whether at least one communication of the one or more communications comprise malicious content based on determining at least one score by the machine learning model; and
blocking the malicious content from being sent to other users of the platform in response to determining that the at least one score denotes that the at least one communication comprises the malicious content.

19. The computer-readable medium of claim 18, wherein the malicious content comprises at least one malicious uniform resource locator (URL).

20. The computer-readable medium of claim 18, wherein the instructions, when executed, further cause:
facilitating, based on the at least one score, banning of at least one account associated with at least one user, of the users, that initiated sending of the malicious content to one or more of the users.
